(19) United States
(12) Patent Application Publication
(10) Pub. No.: US 2014/0150918 A1
(43) Pub. Date: Jun. 5, 2014

(54) VIBRATION REDUCING RUBBER COMPOSITION

(71) Applicants: Hyundai Motor Company, Seoul (KR); Hwaseung Materials Co., Ltd., Yangsan (KR); Kia Motors Corporation, Seoul (KR)

(72) Inventors: Heon-Seop Jung, Euiwang (KR); Byung-Kwon Min, Yongin (KR); Chang-Kuk Im, Seoul (KR); Woo-Won Youn, Busan (KR); Hyun-Ho Park, Yangsan (KR); Hee-Soo Woo, Busan (KR)

(21) Appl. No.: 13/924,079

(22) Filed: Jun. 21, 2013

(30) Foreign Application Priority Data
Dec. 5, 2012 (KR) 10-2012-0140539

(51) Int. Cl. C08K 3/04; F16L 11/04

(52) U.S. Cl. CPC C08K 3/04; F16L 11/04
USPC 138/177; 524/574

(57) ABSTRACT

Disclosed is a vibration reducing rubber composition, more specifically to a vibration reducing rubber composition that reduces inflow of vibration and noise generated from an engine into an interior of an automobile, and improves riding comfort, emotional quality and merchantable quality of the automobile, by providing a particular formulation of a heater hose composition, which comprises ethylene propylene rubber (EPDM), fast extruding furnace (FEF) carbon black and semi reinforcing furnace (SRF) carbon black.

### CROSS-REFERENCE TO RELATED APPLICATION

The present application claims priority of Korean Patent Application Number 10-2012-0140539 filed Dec. 5, 2012, the entire contents of which application is incorporated herein for all purposes by this reference.

### BACKGROUND

(a) Technical Field

The present invention relates to a vibration reducing rubber composition, which reduces vibration transfer, and more specifically to a vibration reducing rubber composition, which reduces vibration and noise by controlling the proportion of an ethylene propylene rubber (EPDM) composition used in the existing heater hose for an automobile, and the like.

(b) Background Art

Due to recent increases of interest in the environment and energy in the automobile industry, many automobile manufacturing companies have developed technologies that reduce the weight and size of an automobile body in order to enhance fuel efficiency, as well as technologies that provide a power train with a high power in order to satisfy consumer demands.

Due to the development of these technologies, automobile power has been continuously increased to 10% or more than the engine power of the previous generation. However, as a result of the decrease in weight and size of automobile bodies, vibration and noise generated from the high power engine are more easily transferred to the compact and lightweight automobile body.

In order to solve this problem, automobile manufacturing companies are developing technologies for improving vibration resistance efficiency of automobile parts. The improvement of the vibration resistance efficiency, thus, became a very importance factor in automobile development, and became an unavoidable global trend. Further, because consumer complaints related to vibration and noise are being continuously filed, automobile manufacturing companies are actively trying to develop technologies for reducing vibration and noise.

A flow route of vibration and noise into the interior of an automobile can be largely divided into two categories, with the first route flowing into the automobile interior through a solid medium, and the second route flowing into the automobile interior through an air medium. There are many causes for the flow of vibration and noise into the automobile interior through the first route, one of them being a heater hose connected into the automobile engine.

FIG. 1 is a perspective view showing a heater hose for an automobile. A heater unit inside of an automobile is connected to an automobile engine through the heater hose. As such, the heater hose becomes a passage for transferring the vibration of the automobile engine into the indoor. Accordingly, the heater hose is one element that increases vibration and noise in the interior of the automobile. Further, in addition to the vibration of the engine itself, high frequency noise of combustion generated inside of the engine cylinder is also transferred into the interior of the automobile through the heater hose.

Further, characteristics applied to a heater hose using a conventional ethylene propylene rubber (EPDM:Ethylene Propylene Diene Monomer) are limited only to durability, such as thermal resistance, coolant resistance and burst pressure performance, and ease of installation. However, such characteristics are irrelevant to insulating property.

Korean Patent Registration No. 10-0890132 (2009.03.16) describes a technology for reducing noise of a heater. However, the technology is irrelevant to improving insulating efficiency of the heater hose material itself because it relates to noise reduction by structural change of the heater hose and a pipe.

The description provided above as a related art of the present invention is just for helping understanding the background of the present invention and should not be construed as being included in the related art known by those skilled in the art.

### SUMMARY OF THE DISCLOSURE

The present invention provides a vibration reducing rubber composition, which shows vibration and noise reduction effects in the rubber composition itself by controlling the formulation of the composition. More particularly the present invention provides a vibration reducing rubber composition comprising ethylene propylene rubber (EPDM) having a low viscosity, fast extruding furnace (FEF) carbon black and semi reinforcing furnace (SRF) carbon black, wherein the formulation of the composition is controlled to provide improved noise vibration (NVH) quality, particularly when applied to an automobile heater hose.

According to one aspect, the present invention provides a vibration reducing rubber composition comprising ethylene propylene rubber (EPDM), fast extruding furnace (FEF) carbon black and semi reinforcing furnace (SRF) carbon black.

According to various embodiments, the vibration reducing rubber composition further comprises a filler and a plasticizer.

According to various embodiments, Mooney viscosity (ML1+8, 125° C.) of the ethylene propylene rubber (EPDM) is about 48 to 68.

According to various embodiments, the composition comprises the semi reinforcing furnace (SRF) carbon black in an amount of about 100 to 140 parts by weight, based on 100 parts by weight of the fast extruding furnace (FEF) carbon black.

According to an exemplary embodiment of the present invention, the composition comprises the fast extruding furnace (FEF) carbon black in an amount of about 60 parts by weight, the semi reinforcing furnace (SRF) carbon black in an amount of about 85 parts by weight, the filler in an amount of about 30 parts by weight and the plasticizer in an amount of about 75 parts by weight, based on 100 parts by weight of the ethylene propylene rubber (EPDM).

According to a further aspect, the present invention provides a heater hose for an automobile comprising the vibration reducing rubber composition.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view showing a conventional heater hose for an automobile;

FIG. 2 is a structural formula of an ethylene propylene rubber (EPDM: Ethylene Propylene Diene Monomer);

FIG. 3 is a storage modulus (E′) graph of a conventional heater hose for an automobile;

FIG. 4 is a graph comparing noise generated when cold accelerating of automobile engines; and

FIG. 5 is a graph comparing noise generated when warm accelerating of automobile engines.

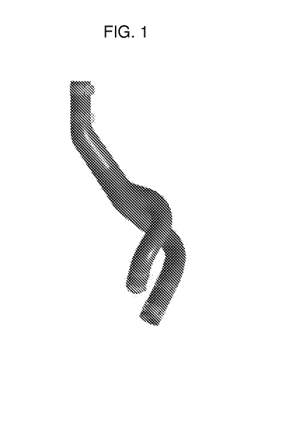

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terms and the words used in the specification and claims should not be construed with common or dictionary meanings, but construed as meanings and conception coinciding the spirit of the invention based on a principle that the inventors can appropriately define the concept of the terms to explain the invention in the optimum method. Therefore, embodiments described in the specification and the configurations shown in the drawings are not more than the most preferred embodiments of the present invention and do not fully cover the spirit of the present invention. Accordingly, it should be understood that there may be various equivalents and modifications that can replace those when this application is filed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention, which relates to a rubber composition having improved vibration reducing efficiency, will be described in detail with reference to the accompanying drawings.

The vibration reducing rubber composition according to the present invention comprises ethylene propylene rubber (EPDM) as a base material (i.e. a main component). The vibration reducing rubber composition further comprises fast extruding furnace (FEF) carbon black, semi reinforcing furnace (SRF) carbon black and the like.

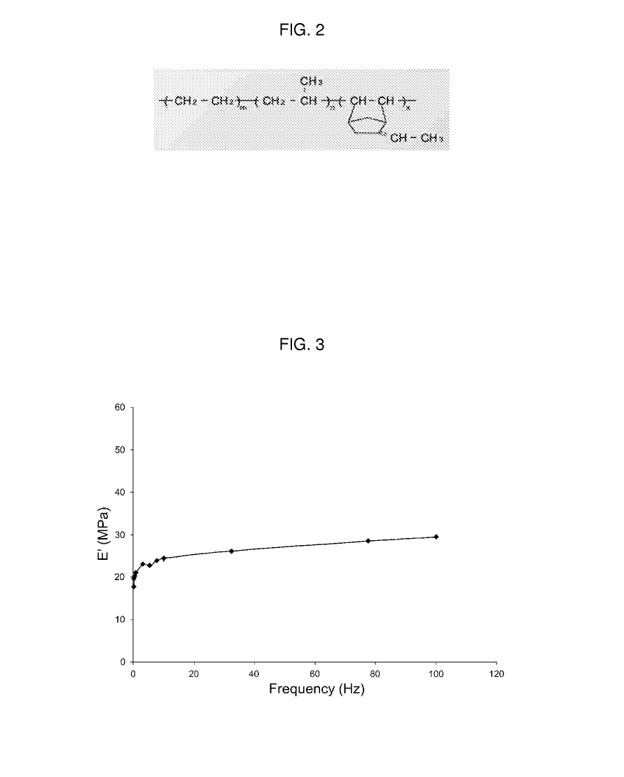

FIG. 2 shows a structural formula of an ethylene propylene rubber (EPDM: Ethylene Propylene Diene Monomer) that can be used in the present composition. The physical properties of the ethylene propylene rubber (EPDM) composition can be modified as desired by adding a filler, a plasticizer and the like to the ethylene propylene rubber (EPDM) composition.

Through such modification methods, the ethylene propylene rubber (EPDM) composition used in a conventional heater hose for an automobile was improved in durability due to its object to improve durability. However, vibration resistant efficiency of the ethylene propylene rubber (EPDM) composition was still weak.

The vibration reducing efficiency can be determined by storage modulus (E′). FIG. 3 shows a storage modulus (E′) graph of a conventional heater hose for an automobile, with the test condition being 0.1 to 100 Hz, 24° C. As shown in FIG. 3, it was found that vibration reducing efficiency of the conventional ethylene propylene rubber (EPDM) composition was insufficient because its storage modulus was as high as 28.9 MPa.

The storage modulus, also called dynamic modulus, means the energy stored by elasticity without loss, and it can used as a barometer of the stored energy. In other words, storage modulus represents a degree of restoration of an elastic body by periodic modification.

As the storage modulus (E′) increases, the elastic body approaches a perfect elastic body, where the perfect elastic body satisfies the proportional relation between stress (a) and strain (ε) (σ=Me, M is modulus). Namely, internal stress of the elastic body and phase difference (δ) of the elastic body strain become 0°, and the internal stress of the elastic body increases in proportion to externally applied frequency.

In the case of an automobile, when a part having high storage modulus (E′) is applied around an engine where vibration is mostly generated, riding comfort of the automobile may thereby be reduced because the vibration of the engine is transferred to the automobile body. After all, in order to reduce the vibration of an automobile, the vibration generated by the engine should be reduced by using a part having a low storage modulus.

In order to provide a rubber composition that reduces vibration, many tests were performed, and consequently, it was determined that when Mooney viscosity (ML1+8, 125° C.) of the ethylene propylene rubber (EPDM) is about 48 to 68, the rubber composition demonstrates a vibration reducing effect.

In particular, it was determined that physical properties, such as hardness, tensile strength, elongation rate and the like, of the composition are rapidly reduced when the Mooney viscosity (ML1+8, 125° C.) of the ethylene propylene rubber (EPDM) is less than 48. On the other hand, when the Mooney viscosity (ML1+8, 125° C.) excesses 68, the vibration reducing efficiency is not significantly improved due to little change in storage modulus.

Further, it is preferred that the amount of the semi reinforcing furnace (SRF) carbon black is about 100 parts by weight to about 140 parts by weight, based on 100 parts by weight of the fast extruding furnace (FEF) carbon black. According to a particularly preferred embodiment, the amount of the semi reinforcing furnace (SRF) carbon black is about 140 parts by weight, based on 100 parts by weight of the fast extruding furnace (FEF) carbon black.

In particular, it was determined that the vibration reducing efficiency is not significantly improved when the amount of the semi reinforcing furnace (SRF) carbon black is less than about 100 parts by weight, based on 100 parts by weight of the fast extruding furnace (FEF) carbon black. On the other hand, when the amount of the semi reinforcing furnace (SRF) carbon black exceeds about 140 parts by weight, there is a problem of rapid reduction of durability of the vibration reducing rubber composition.

Specifically, it was confirmed that a rubber composition manufactured in accordance with the present invention reduces the vibration generated from an engine as outlined by the following Table 1.

TABLE 1

| | | | Comp. | | | |
|---|---|---|---|---|---|---|
| Test Item | | | Exam. | Exam. 1 | Exam. 2 | Exam. 3 |
| Mooney viscosity of | | (ML | 82.0 | 58.0 | 82.0 | 58.0 |
| ethylene propylene | | 1 + 8, | | | | |
| rubber (EPDM) | | 125° C.) | | | | |
| Formulation | EPDM | parts by | 100 | 100 | 100 | 100 |
| | | weight | | | | |
| | FEF(N550) | parts by | 150 | 150 | 75 | 60 |
| | | weight | | | | |
| | SRF(N774) | parts by | — | — | 75 | 85 |
| | | weight | | | | |
| | Filler | parts by | 55 | 55 | 55 | 30 |
| | | weight | | | | |
| | Plasticizer | parts by | 85 | 85 | 85 | 75 |
| | | weight | | | | |
| Status | hardness | Hs | 74 | 73 | 62 | 65 |
| Physical | Tensile | kgf/cm² | 110 | 105 | 90 | 105 |
| Property | Strength | | | | | |
| | Elongation | % | 350 | 340 | 340 | 330 |
| | Rate | | | | | |
| Thermal | Hardness | Hs | +8 | +10 | +10 | +7 |
| Ageing | Change | | | | | |
| Resistance | Tensile | % | +5 | +3 | +7 | +4 |
| (135° C. × | Strength | | | | | |
| 168 hr) | Change | | | | | |
| | Elongation | % | −50 | −57 | −58 | −49 |
| | Rate | | | | | |
| | Change | | | | | |
| Permanent Compression | | % | 50 | 58 | 55 | 47 |
| Decrease Rate | | | | | | |
| (120° C. × 72 hr) | | | | | | |
| DMA | Storage | E′(MPa) | 28.86 | 22.86 | 20.02 | 16.32 |
| (100 Hz, | Modulus | | | | | |
| 24° C.) | Phase | tan δ | 0.19 | 0.16 | 0.17 | 0.19 |
| | Difference | | | | | |

The Table 1 is a table showing a Comparative Example, which is a conventional composition, and Example 1 to Example 3, which are in accordance with the present invention. In Examples 1 to 3 and Comparative Example 1, vibration reducing rubber compositions were manufactured by using ethylene propylene rubbers (EPDM) having low viscosity, particularly a rubber having the Mooney viscosity (ML1+8, 125° C.) of 82 in the Comparative Example and Example 2, and a rubber having the Mooney viscosity (ML1+8, 125° C.) of 58 in Examples 1 and 3. In the Table, parts by weight are based on 100 parts by weight of EPDM.

Looking at the results of Example 1 in further detail, as the result of the physical property tests, the storage modulus of Example 1 was lowered 20% as compared with the Comparative Example. Accordingly, it was found that the vibration reducing effect was improved by the composition according to the present invention. Further, the results of the status physical property test, the thermal ageing resistance test and the permanent compression decrease rate test of Example 1 were not significantly different than the results of the Comparative Example. The vibration reducing rubber composition of Example 1 had similar durability compared to that of the conventional rubber composition (Comparative Example), and further demonstrated low storage modulus. Accordingly, it was confirmed that the present composition provides an improved vibration reducing efficiency.

Looking at the results of Example 2 of Table 1 in further detail, based on 100 parts by weight of the ethylene propylene rubber (EPDM), the Comparative Example contained the fast extruding furnace (FEF) carbon black as a stiffener in an amount of 150 parts by weight, while Example 2 contained the fast extruding furnace (FEF) carbon black in an amount of 75 parts by weight and the semi reinforcing furnace (SRF) carbon black in an amount of 75 parts by weight. Namely, the fast extruding furnace (FEF) carbon black and the semi reinforcing furnace (SRF) carbon black were added at the ratio of 1:1.

As the result of the physical property tests of Example 2, the storage modulus of Example 2 was lowered 30% compared to that of the Comparative Example. Further, the results of the status physical property test, the thermal ageing resistance test and the permanent compression decrease rate test for Example 2 were not significantly different with the results of the Comparative Example. Namely, the physical properties of Example 2 were similar to the physical properties of the Comparative Example, but the storage modulus of Example 2 was lower. Accordingly, it was confirmed that the composition of the present invention provides improved vibration reducing efficiency.

Looking at the results of Example 3 of Table in more detail, a vibration reducing rubber composition of the present invention was provided which used an ethylene propylene rubber (EPDM) having the Mooney viscosity (ML1+8, 125° C.) of 58. Based on 100 parts by weight of the ethylene propylene rubber (EPDM), the fast extruding furnace (FEF) carbon black was added in an amount of 60 parts by weight and the semi reinforcing furnace (SRF) carbon black was added in an amount of 85 parts by weight. Namely, the fast extruding furnace (FEF) carbon black and the semi reinforcing furnace (SRF) carbon black were added at the ratio of 1:1.4.

As the result of the physical property tests of Example 3, the storage modulus of Example 3 was lowered 56% compared to that of the Comparative Example. Further, the results of the status physical property test, the thermal ageing resistance test and the permanent compression decrease rate test for Example 3 were not significantly different than the results of the Comparative Example. Further, the physical properties of Example 3 were similar to the physical properties of the Comparative Example, but the storage modulus of Example 3 was lower than that of the Comparative Example. Accordingly, it was confirmed that the composition of the present invention provides improved vibration reducing efficiency.

In the Table 1, the vibration reducing effect of Example 3 was the highest because its storage modulus was the lowest. Accordingly, the mixing ratio of Example 3 was the most preferred for manufacturing a vibration reducing rubber composition. Thus, according this preferred embodiment, the vibration reducing rubber composition of the present invention is characterized in that the Mooney viscosity (ML1+8, 125° C.) of the ethylene propylene rubber (EPDM) is 58, the amount of the fast extruding furnace (FEF) carbon black is 60 parts by weight, the amount of the semi reinforcing furnace (SRF) carbon black is 85 parts by weight, the amount of the filler is 30 parts by weight and the amount of the plasticizer is 75 parts by weight, based on 100 parts by weight of ethylene propylene rubber (EPDM).

TABLE 2

| | | Comparative | |
|---|---|---|---|
| Section | Unit | Example | Example 3 |
| ethylene propylene | wt % | 25.5 | 29.5 |
| rubber (EPDM) | | | |
| Stiffener | wt % | 39.0 | 38.1 |
| Filler | wt % | 14.8 | 11.3 |
| Activating Agent | wt % | 2.2 | 2.5 |
| Cross-linking Agent | wt % | 0.12 | 0.10 |
| Accelerating Agent | wt % | 0.8 | 1.0 |
| Plasticizer | wt % | 17.1 | 16.9 |
| Processing Aid | wt % | 0.5 | 0.6 |
| Total | wt % | 100 | 100 |

Table 2 compares ingredients of Example 3, representing the vibration reducing rubber composition of the present invention, with ingredients of Comparative Example by wt %. As shown in the table, a preferred vibration reducing rubber composition of the present invention comprises 29.5 wt % ethylene propylene rubber (EPDM), 38.1 wt %, stiffener (comprising fast extruding furnace (FEF) carbon black and semi reinforcing furnace (SRF) carbon black), 11.3 wt % filler, 2.5 wt % activating agent, 0.1 wt % cross-linking agent, 1.0 wt % accelerating agent, 16.9 wt % plasticizer and 0.6 wt % processing aid.

In order to improve the vibration reducing efficiency by increasing tufftriding, in Example 3, the ethylene propylene rubber (EPDM) was added in an amount of 29.5 wt %, which was 4 wt % higher than the Comparative Example. It is further preferred to add the ethylene propylene rubber (EPDM) in an amount of 30 wt %.

Further, the Mooney viscosity (ML1+8, 125° C.) of the ethylene propylene rubber (EPDM) was lowered from 82 (Comparative Example) to 58 (Example 3) in order to help improving tufftriding of the ethylene propylene rubber (EPDM).

In order to further reduce the hardness and the viscosity of the ethylene propylene rubber (EPDM), Example 3 added carbon black as a stiffener in an amount reduced 1 wt % as compared with the Comparative Example. According to the present invention, the carbon black may be fast extruding furnace (FEF) carbon black (e.g. size: 50 nm), semi reinforcing furnace (SRF) carbon black (e.g. size: 70 nm) and the like, and it is preferred that the ratio of the fast extruding furnace (FEF) carbon black and the semi reinforcing furnace (SRF) carbon black is about 1:1. According to test results, it is more preferred that the ratio of the fast extruding furnace (FEF) carbon black and the semi reinforcing furnace (SRF) carbon black is about 1:1.4. Thus, it is preferred that the ratio of the fast extruding furnace (FEF) carbon black and the semi reinforcing furnace (SRF) carbon black is in a range of about 1:1 to 1:1.4, which is an effective value that provides a vibration reducing effect of the rubber.

Further, in order to prevent common defects caused by increased sulfur content, such as thermal resistance reduction and permanent compression decrease rate reduction, an EV (Efficient Vulcanization) method can be used, which increase the ratio of a vulcanization accelerator about 0.2 wt % from the existing semi-EV method.

The increase in the vibration reducing efficiency provided by the vibration reducing rubber composition of the present invention comprising the above ingredients is provided by the following Table 3 and Figures.

TABLE 3

| | Cold Idling | Cold Running | Warm Running |
|---|---|---|---|
| Section | Noise | Noise | Noise |
| Noise of Example 3 | Decreased | Decreased | Decreased |
| Compared with | 1 to 2 dBA | 2 dBA | 1 dBA |
| Comparative | | | |
| Example | | | |

Table 3 shows the results of measuring noises after attaching the heater hoses (a) made with the vibration reducing rubber composition of the present invention (Example 3) and(b) made with the conventional rubber composition, to engines. In terms of all of the noises generated when cold idling, cold running and warm running, the noise of the heater hose for an automobile made with the vibration reducing rubber composition of the present invention was lower than the noise of the heater hose for an automobile made with the conventional rubber composition.

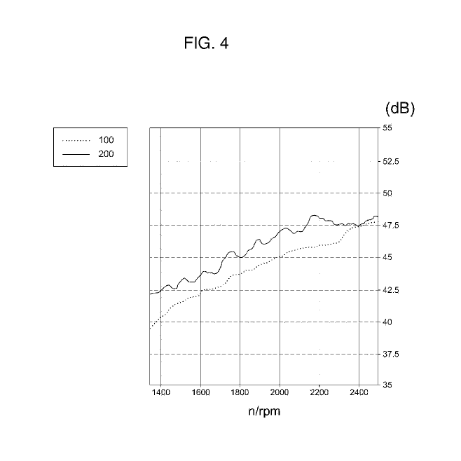

FIG. 4 is a graph comparing noise generated when cold accelerating of automobile engines. Specifically, the graph measures and compares noises generated when cold accelerating of an automobile engine after applying the vibration reducing rubber composition of the present invention (Example 3, depicted by 100 in the graph) and the conventional rubber composition (Comparative Example, depicted by 200 in the graph) to heater hoses for an automobile followed by installing in engines. As shown in the graph, when compared with the Comparative Example, Example 3 showed a low noise of 1 to 2 dBA (A-weighted decibel) on average. This, means that there was a noise reducing effect when cold accelerating of the automobile engine.

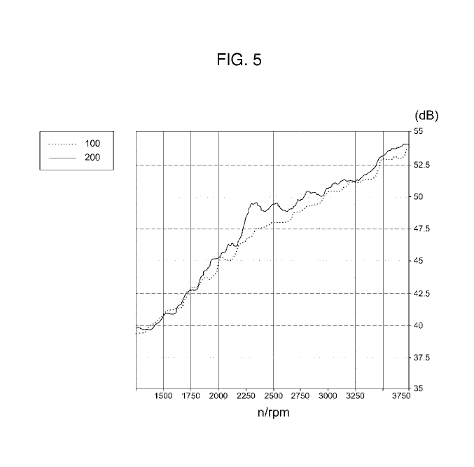

FIG. 5 is a graph comparing noise generated when warm accelerating of automobile engines. Specifically, the graph measures and compares noises generated when warm accelerating of an automobile engine after applying the vibration reducing rubber composition of the present invention (Example 3, depicted by 100 in the graph) and the conventional rubber composition (Comparative Example, depicted by 200 in the graph) to heater hoses for an automobile followed by installing in engines. As shown in the graph, when compared with the Comparative Example, Example 3 showed a low noise of 1 dBA (A-weighted decibel) in average. This means that there was a noise reducing effect when warm accelerating of the automobile engine.

Unlike the rubber composition comprising the ethylene propylene rubber (EPDM) used in the conventional heater hose, the present invention having the constitution described above has an effect of improving the vibration reducing efficiency of the rubber composition by providing a specific proportion of the ingredients.

Further, the present invention improves riding comfort by reducing vibration and noise flowed into an interior of an automobile, and therefore, it can improve emotional quality and merchantable quality of an automobile.

In addition, the present invention improves the said vibration reducing efficiency and further maintains physical properties, such as tensile strength and elongation rate, at a level comparable to the existing products.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. A vibration reducing rubber composition comprising ethylene propylene rubber (EPDM), fast extruding furnace (FEF) carbon black and semi reinforcing furnace (SRF) carbon black.

2. The vibration reducing rubber composition according to claim 1, which further comprises a filler and a plasticizer.

3. The vibration reducing rubber composition according to claim 1, wherein Mooney viscosity (ML1+8, 125° C.) of the ethylene propylene rubber (EPDM) is about 48 to 68.

4. The vibration reducing rubber composition according to claim 1, which comprises about 100 to 140 parts by weigh of the semi reinforcing furnace (SRF) carbon black based on 100 parts by weight of the fast extruding furnace (FEF) carbon black.

5. The vibration reducing rubber composition according to claim 2, which comprises about 60 parts by weight of the fast extruding furnace (FEF) carbon black, about 85 parts by weight of the semi reinforcing furnace (SRF) carbon black, about 30 parts by weight of the filler, and about 75 parts by weight of the plasticizer based on 100 parts by weight of the ethylene propylene rubber (EPDM).

6. A heater hose for an automobile comprising the vibration reducing rubber composition according to claim 1.
